(19) United States
(12) Patent Application Publication
(10) Pub. No.: US 2025/0299302 A1
(43) Pub. Date: Sep. 25, 2025

(54) Diffusion Models for Multi-Garment Virtual Try-On or Editing

(71) Applicant: Google LLC, Mountain View, CA (US)

(72) Inventors: Dawei Yang, Kirkland, WA (US); Yingwei Li, San Jose, CA (US); Nan Liu, New York, NY (US); Luyang Zhu, Seattle, WA (US); Irena Kemelmaher, Seattle, WA (US); Hao Peng, Kirkland, WA (US)

(21) Appl. No.: 19/003,906

(22) Filed: Dec. 27, 2024

Related U.S. Application Data
(60) Provisional application No. 63/616,294, filed on Dec. 29, 2023.

(51) Int. Cl. G06T 5/60; G06T 3/4046; G06T 5/50; G06T 5/70; G06T 11/60

(52) U.S. Cl. CPC G06T 5/60; G06T 3/4046; G06T 5/50; G06T 5/70; G06T 11/60; G06T 2207/20081; G06T 2207/20084; G06T 2207/30196; G06T 2210/16; G06T 2210/36

(57) ABSTRACT

Provided are systems and methods for multi-garment virtual try-on and editing, example implementations of which can be referred to as M&M VTO. The proposed systems allow users to visualize how various combinations of garments would look on a given person. The input for this method can include multiple garment images, an image of a person, and optionally a text description for the garment layout. The output is a high-resolution visualization of how these garments would look on the person in the desired layout. For instance, a user can input an image of a shirt, an image of a pair of pants, a description such as “rolled sleeves, shirt tucked in”, and an image of a person. The output would then be a visual representation of how the person would look wearing these garments in the specified layout.

### RELATED APPLICATIONS

This application claims priority to and the benefit of U.S. Provisional Patent Application No. 63/616,294, filed Dec. 29, 2023. U.S. Provisional Patent Application No. 63/616,294 is hereby incorporated by reference in its entirety.

### FIELD

The present disclosure relates generally to machine learning models. More particularly, the present disclosure relates to machine learning models for multi-garment virtual try-on and editing.

### BACKGROUND

In the field of virtual shopping and fashion design, one of the significant challenges is to provide users with a realistic representation of how different clothing items would look on them without the need for physical fitting. This is particularly relevant in online shopping scenarios, where the potential for fitting the garment is absent. Conventional solutions like static images or models often fail to capture the unique body proportions, pose, and personal characteristics of individual users.

Existing virtual try-on (VTO) technologies attempt to address this problem by synthesizing an image of a person wearing a specific garment based on an image of the person and an image of the garment. While these technologies have shown some promise, they are not without their limitations. For instance, many current methods focus on single garment VTO, which limits the user's ability to visualize combinations of different garments or outfits.

Moreover, many conventional VTO solutions employ multi-stage or cascaded models, which often includes super-resolution stages. These models typically first create a low-resolution image and then progressively increase the resolution. However, this approach can lead to loss of important garment details, especially in the case of multi-garment VTO, as the base model does not have enough capacity to create intricate warps and occlusions based on a person's body shape at a higher resolution.

Another issue with existing solutions is the loss of person identity during the VTO process. This is due to the use of ‘clothing-agnostic’ representations that effectively erase the current garment to be replaced by the VTO, but in the process remove a significant amount of identity information, such as body shape, pose, and distinguishing features like tattoos. This often results in a loss of realism in the output images, reducing user satisfaction.

Therefore, there remains a need for an improved VTO system that can accurately synthesize high-resolution multi-garment VTO images, preserve person identity, and provide a more user-friendly and efficient solution, thereby overcoming the aforementioned limitations.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for multi-garment try-on, the method comprising: obtaining, by a computing system comprising one or more computing devices, an input set comprising a person image that depicts a person, a first garment image that depicts a first garment, and a second garment image that depicts a second garment; processing, by the computing system, the input set with a machine-learned denoising diffusion model to generate, as an output of the machine-learned denoising diffusion model, a synthetic image that depicts the person wearing the first garment and the second garment; and providing, by the computing system, the synthetic image as an output.

Another example aspect of the present disclosure is directed to a computer system configured to train a denoising diffusion model to perform virtual try-on by performing operations. The operations include performing a plurality of training iterations, each training iteration comprising: obtaining an image pair, the image pair comprises a target image of a person wearing a garment and a garment image of the garment; creating a garment-agnostic image of the person based on the target image and the garment image; processing the garment image and the garment-agnostic image of the person with the denoising diffusion model to generate a synthetic image that depicts the person wearing the garment; and modifying one or more values of one or more parameters of the denoising diffusion model based on a loss function that compares the synthetic image to the target image. The plurality of training iterations are performed over at least two training stages, wherein a first training stage is performed on images having a first resolution, and wherein a second, subsequent training stage is performed on images having a second resolution that is larger than the first resolution.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a graphical diagram of an example machine learning model performing multi-garment try-on according to example embodiments of the present disclosure.

FIG. 2 depicts a graphical diagram of an example machine learning model architecture according to example embodiments of the present disclosure.

FIG. 3 depicts a graphical diagram of an example machine learning model architecture according to example embodiments of the present disclosure.

FIG. 4A depicts a block diagram of an example computing system according to example embodiments of the present disclosure.

FIG. 4B depicts a block diagram of an example computing device according to example embodiments of the present disclosure.

FIG. 4C depicts a block diagram of an example computing device according to example embodiments of the present disclosure.

Reference numerals that are repeated across plural figures are intended to identify the same features in various implementations.

### DETAILED DESCRIPTION

Generally, the present disclosure is directed to systems and methods for multi-garment virtual try-on and editing, example implementations of which can be referred to as M&M VTO. The proposed systems allow users to visualize how various combinations of garments would look on a given person. The input for this method can include multiple garment images, an image of a person, and optionally a text description for the garment layout. The output is a high-resolution visualization of how these garments would look on the person in the desired layout. For instance, a user can input an image of a shirt, an image of a pair of pants, a description such as “rolled sleeves, shirt tucked in”, and an image of a person. The output would then be a visual representation of how the person would look wearing these garments in the specified layout.

In some implementations, the proposed techniques can be implemented using a single-stage diffusion-based model. This model allows for the mixing and matching of multiple garments while preserving and warping intricate garment details. This design eliminates the need for super resolution cascading, which is a common feature in other virtual try-on methods. Instead, the proposed techniques can directly synthesize high-resolution images, allowing for a more accurate representation of the garments and the person wearing them.

In some implementations, the proposed diffusion model can be structured according to a unique architecture design that helps to separate the process of denoising from the extraction of person-specific features. This separation allows for a more effective fine-tuning strategy for preserving the identity of the person in the image. In comparison to other methods, which may require a large model per individual, example implementations of the proposed method drastically reduce the model size per individual, making it a more efficient and practical solution.

Thus, another example aspect is directed to an efficient fine-tuning strategy for preserving person identity. This strategy includes finetuning person features only, rather than the entire model. This approach not only produces higher quality results but also significantly reduces the finetuned model size per new individual.

Another innovative feature of the proposed techniques is its use of text inputs to control the layout of multiple garments. The technology can include the use of a text embedding model that has been specifically fine-tuned for the virtual try-on task. This feature allows users to specify the layout of the garments in a more precise and detailed manner, enhancing the accuracy and realism of the output visualization.

For example, some implementations of the present disclosure can include the use of text-based labels representing various garment layout attributes. These attributes can include things like rolled sleeves, a tucked in shirt, and an open jacket. Thus, some implementations can formulate attribute extraction as an image captioning task and finetune a text embedding model using only a small number of labeled images. This feature allows for the automatic extraction of accurate labels for the whole training set.

Another aspect of the present disclosure is directed to a progressive training strategy. This strategy includes beginning the model training with lower-resolution images and gradually moving to higher-resolution ones during the single stage training. This design allows the model to better learn and refine high-frequency details, leading to a more accurate and detailed output visualization.

More particularly, one example aspect of the present disclosure is directed to a computer-implemented method for multi-garment try-on. This method includes obtaining an input set that includes an image of a person and images of one or more garments. The input set can be processed using a machine-learned denoising diffusion model to create a synthetic image that depicts the person wearing the garments. This synthetic image can then be provided as an output. This technology can be used in a variety of applications, such as online shopping platforms, where customers can virtually try on different garments before making a purchase.

The denoising diffusion model used in the present disclosure can be a single-stage model. This means that the model operates in one stage rather than multiple stages, which can simplify the process and make it more efficient. The single-stage model can take the input set and directly generate the synthetic image, without needing to go through intermediate stages. For example, the model can take an image of a person and an image of a garment, and directly generate an image of the person wearing the garment.

The input set for the present disclosure can also include a textual layout description. This textual layout description can provide additional information about how the garments should be worn. For instance, the textual layout description can specify that a shirt should be tucked in or that the sleeves should be rolled up. This allows the technology to generate more accurate and realistic synthetic images.

The present disclosure can process the textual layout description with a text embedding model to generate a text embedding. The text embedding model can be finetuned on training data that includes clothing descriptions. This allows the model to accurately interpret the textual layout description and incorporate the specified layout into the synthetic image. For example, if the textual layout description specifies that a shirt should be tucked in, the model can generate a synthetic image where the shirt is indeed tucked in.

The machine-learned denoising diffusion model of the present disclosure can include a first garment encoder and a second garment encoder. These encoders can generate garment embeddings from the garment images. The garment embeddings can capture important features of the garments, such as their color, texture, and shape. These features can then be used to generate the synthetic image. For example, if the first garment image depicts a red shirt and the second garment image depicts blue jeans, the garment encoders can generate embeddings that capture the color and texture of the shirt and jeans.

The machine-learned denoising diffusion model of the present disclosure can also include a person encoder. The person encoder can generate a person encoding from the person image. This person encoding can capture important features of the person, such as their body shape and pose. These features can then be used to generate the synthetic image. For example, if the person image depicts a person with a certain body shape and pose, the person encoder can generate an encoding that captures these features.

In some implementations of the present disclosure, only the person encoding may be finetuned. This can make the model more efficient and avoid overfitting. For example, if the person encoding is finetuned, the model can accurately capture the features of the person without overfitting to the specific garments worn by the person in the person image.

In some implementations, the machine-learned denoising diffusion model of the present disclosure can operate over multiple denoising time steps. A U-Net encoder can take the current time step as an input, while the garment encoders and person encoder can operate only once to generate persistent embeddings. This can make the model more efficient and allow it to generate more accurate synthetic images. For example, if the model operates over multiple time steps, it can gradually refine the synthetic image at each time step to make it more realistic.

A U-Net model can be a convolutional neural network architecture that is characterized by its U-shaped structure, which consists of a contracting path (e.g., to capture context) and a symmetric expanding path (e.g., for precise localization).

The input set for the present disclosure can also include pose data for the garments and the person. This pose data can provide additional information about how the garments should be worn and how the person is posing. This allows the model to generate more accurate and realistic synthetic images. For example, if the pose data specifies that the person is standing in a certain pose and that the garments should be worn in a certain way, the model can generate a synthetic image that accurately reflects this pose data.

In some implementations, the machine-learned denoising diffusion model of the present disclosure can be progressively trained on increasing image resolutions. This can allow the model to generate high-quality synthetic images. For example, the model can initially be trained on low-resolution images and then progressively trained on higher-resolution images. This allows the model to gradually learn to generate high-quality synthetic images, which can improve the realism and accuracy of the images.

Another example aspect of the present disclosure is directed to a computer system that trains a denoising diffusion model to perform virtual try-ons. The virtual try-on method can be used to generate a synthetic image of a person wearing a specific garment, based on an image of the person and an image of the garment. The system can be utilized in various applications such as online shopping platforms, fashion design software, or virtual reality environments where users can virtually try on different clothing items.

The computer system in the present disclosure performs several training iterations to train the denoising diffusion model. Each of these iterations includes obtaining an image pair, which includes a target image of a person wearing a garment, and a garment image of the garment itself. For instance, the target image could be a photograph of a model wearing a dress, while the garment image could be an image of the dress laid out on a flat surface.

In the training process, the system creates a garment-agnostic image of the person based on the target image and the garment image. This image essentially represents the person without the specific garment, allowing the model to focus on the person's body shape and pose. This could be done by segmenting the person from the garment in the target image and applying various image processing techniques.

The denoising diffusion model then processes the garment image and the garment-agnostic image of the person to generate a synthetic image. This synthetic image depicts the person wearing the garment.

The training process also includes modifying one or more values of one or more parameters of the denoising diffusion model. This is based on a loss function that compares the synthetic image to the target image. The loss function could measure the difference between the synthetic image and the target image in terms of color, texture, shape, or other visual features. The model could use optimization algorithms like gradient descent to minimize the loss function and improve the accuracy of the synthetic image.

One aspect of the training approach is that the training iterations are performed over at least two training stages. The first training stage is performed on images having a first resolution. For instance, the system could start by training the model on low-resolution images to learn basic features of persons and garments.

The second, subsequent training stage is performed on images having a second resolution that is larger than the first resolution. This allows the model to learn more detailed and intricate features of persons and garments. For example, the model could learn high-frequency details like the texture and pattern of garments.

Thus, the present disclosure also describes a progressive training paradigm for the denoising diffusion model. The idea is to initialize the higher resolution diffusion models using a pre-trained lower resolution one. This approach is beneficial because it does not require modifying or adding new components to the architecture, making it easy to implement. For instance, the model could start by generating synthetic images at a lower resolution, and then gradually increase the resolution as the training progresses.

Another aspect includes a strategy for efficient finetuning for person identity. This includes finetuning the person features instead of the whole diffusion model, which greatly reduces the optimizable weights. For example, the system could adjust the parameters related to the person's body shape and pose without affecting the parameters related to the garment or the image synthesis process.

The systems and methods of the present disclosure provide a number of technical effects and benefits in the field of image processing and virtual garment try-on technology. These effects are not only valuable in enhancing the user experience but also contribute significantly to the advancement of image synthesis techniques.

One technical effect of the present disclosure is the application of a single-stage diffusion-based model for the generation of highly accurate and detailed virtual try-on images. Unlike the traditional multi-stage models, this single-stage model eliminates the need for super-resolution cascading, thereby enhancing computational efficiency and accuracy. This inventive step offers a significant technical effect as it allows for the direct synthesis of high-resolution images, thereby preserving and accurately representing intricate garment details.

The architecture design of the diffusion model also provides a substantial technical effect. It has been designed to distinctly separate the denoising process from the extraction of person-specific features, thereby allowing for a more effective fine-tuning strategy for identity preservation. This design not only enhances the quality of the output but also significantly reduces the size of the fine-tuned model per individual, making it a more efficient and practical solution.

A further technical effect is a progressive training strategy. This strategy, which includes starting the model training with lower-resolution images and gradually moving to higher-resolution ones, allows the model to better learn and refine high-frequency details. This technical effect leads to more accurate and detailed output visualizations, thus improving the overall quality of the virtual try-on experience.

Another technical effect is the efficient finetuning for person identity preservation. By finetuning only the person features, as opposed to the entire model, the system not only produces higher-quality results but also significantly reduces the size of the fine-tuned model per individual. This approach results in a more efficient system, both in terms of storage requirements and computational resources.

With reference now to the Figures, example embodiments of the present disclosure will be discussed in further detail.

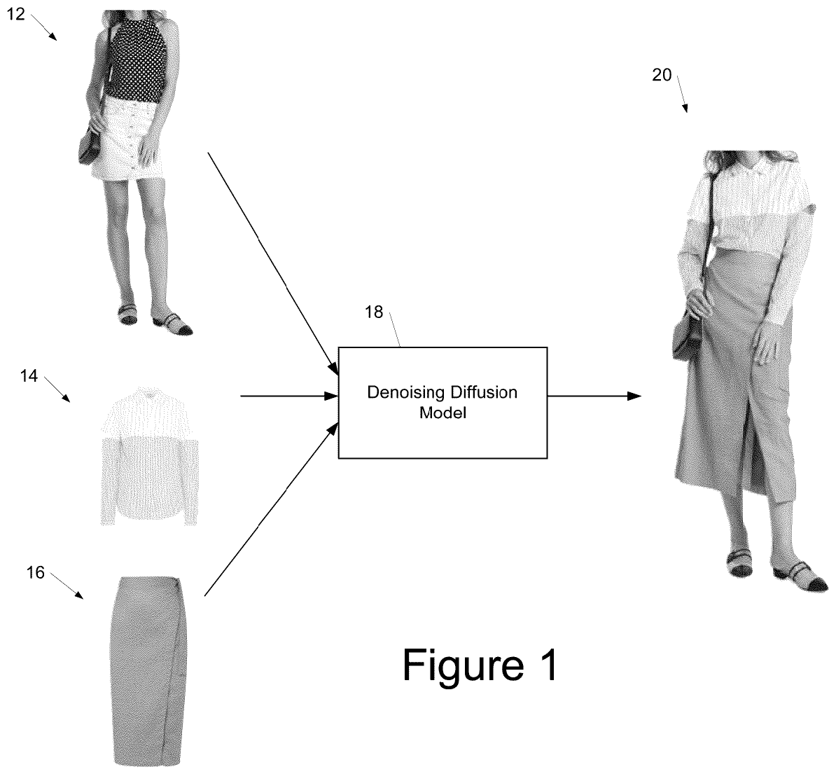

FIG. 1 provides a high-level illustration of how the present disclosure functions in the context of a virtual try-on scenario. As depicted, the system begins with a person image 12 that depicts a person, a first garment image 14 that depicts a first garment, and a second garment image 16 that depicts a second garment. In this context, the first garment image 14 and second garment image 16 can be any items of clothing such as a shirt, pants, a dress, or a jacket, among others. These images can be obtained through various methods such as a digital camera, a scanner, or they can be pre-existing digital images.

The depicted person image 12 can be a digital photo or other type of digital image of a person. This image can be obtained through various methods such as a digital camera, a scanner, or it can be a pre-existing digital image. The person image 12 serves as the canvas upon which the garments depicted in the first and second garment images 14 and 16 will be virtually tried on.

After obtaining these images, the denoising diffusion model 18 processes the images to generate a synthetic image 20 that depicts the person wearing the first garment and the second garment. The denoising diffusion model 18 can be a machine-learned model that has been trained to perform this specific task. The model 18 can learn from a large dataset of person images, garment images, and corresponding synthetic images to learn how to accurately depict a person wearing a garment.

The denoising diffusion model 18 can be a single-stage model that operates in one stage to generate the synthetic image 20. This single-stage operation simplifies the process and makes it more efficient. The model 18 takes the person image 12 and the first and second garment images 14 and 16 as inputs, and directly generates the synthetic image 20. This image 20 depicts the person from the person image 12 wearing the garments from the first and second garment images 14 and 16.

In the synthetic image 20, the person is depicted wearing the first and second garments in a realistic manner. The synthetic image 20 maintains the body shape and pose of the person from the person image 12, while accurately depicting the color, texture, and shape of the garments from the first and second garment images 14 and 16. In essence, the synthetic image 20 provides a high-resolution, realistic visualization of how the person would look wearing the first and second garments.

The synthetic image 20 can be used for various purposes, such as virtual try-on applications in online shopping platforms, where customers can visualize how different garments would look on them before making a purchase. This can enhance the shopping experience by providing a more accurate representation of how the garments would look when worn, which can help customers make more informed purchasing decisions.

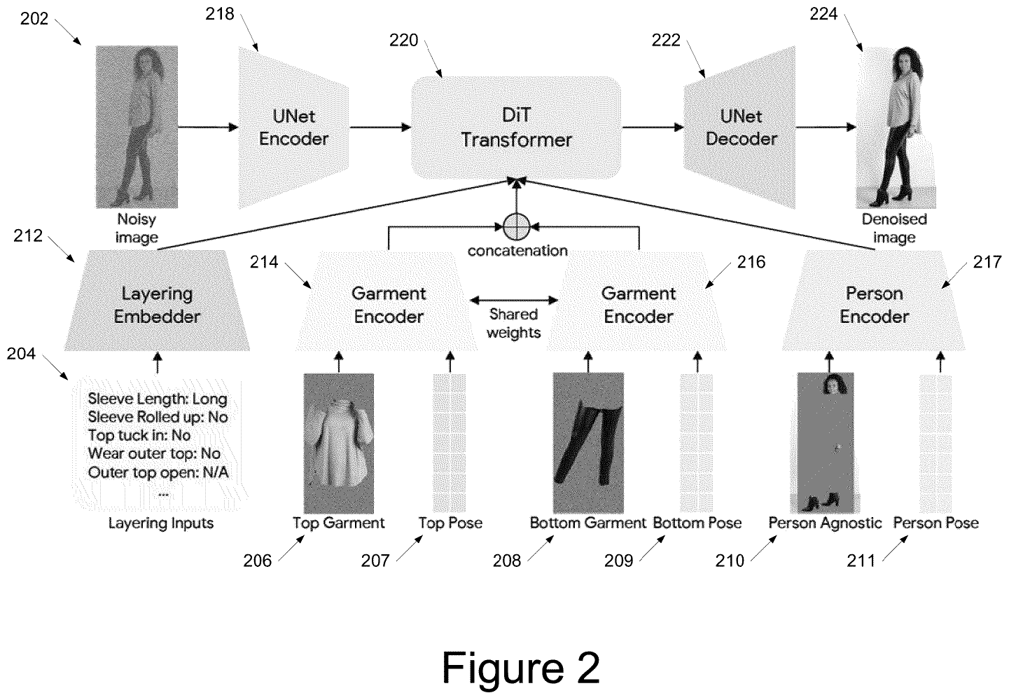

FIG. 2 depicts a more detailed graphical diagram of an example machine learning model performing multi-garment try-on according to example embodiments of the present disclosure.

At the beginning of the process, the system obtains several inputs. These inputs include a noisy input 202, a text input 204, a first garment image 206, first garment pose data 207, a second garment image 208, second garment pose data 209, a person image 210, and person pose data 211. Each of these inputs contributes to the creation of the final synthetic image 224, providing helpful information to the model.

The noisy input 202 serves as an initial input for the system. During training, this input can be a corrupted version of the desired output, providing an initial approximation for the system to refine. The system can obtain this input by adding noise to the original target image, which can be an image of the desired person wearing the desired garments in the desired layout. During inference, the noisy input can be a random noise sample or can be an output from a previous denoising time step.

The text input 204 provides a description of the desired garment layout. This input can be processed by a text encoder 212, which can convert the textual description into a machine-interpretable format, generating a text embedding. This text embedding can provide valuable information about the desired layout of the garments, such as whether the sleeves should be rolled up or the shirt should be tucked in.

The first garment image 206 and the second garment image 208 provide visual representations of the garments to be worn by the person. These images can be processed by the first garment encoder 214 and the second garment encoder 216 respectively, which can generate garment embeddings. These embeddings can capture important features of the garments, such as their color, texture, shape, and size.

To guide the system in correctly positioning the garments on the person, the first garment pose data 207 and the second garment pose data 209 are also provided. These pose data can indicate how the garments are positioned and oriented in their respective images, providing helpful information for the accurate warping and placement of the garments on the person in the synthetic image.

The person image 210 provides a visual representation of the person who will be wearing the garments. This image can be processed by the person encoder 217, which can generate a person embedding. This person embedding can capture important features of the person, such as their body shape, pose, and appearance.

The person pose data 211 provides additional information about the person's pose, guiding the system in accurately positioning the garments on the person in the synthetic image. This pose data can indicate how the person is posed in the person image, such as whether they are standing, sitting, or in motion.

After the system obtains these inputs, it processes them using several components. The U-Net encoder 218 takes the noisy input 202 and generates a set of feature maps. These feature maps provide a detailed representation of the noisy input, capturing its various visual features.

These feature maps are then processed by a DiT transformer 220 along with the text embedding, the first garment embedding, the second garment embedding, and the person embedding. The DiT transformer 220 performs a series of transformations and attention operations, integrating the information from these various inputs to create a refined set of feature maps.

The DiT Transformer architecture, also known as Document Image Transformer, is a self-supervised pre-trained model. It leverages large-scale unlabeled text images to train the model. The architecture utilizes the Transformer model as its backbone and is employed in various vision-based Document AI tasks such as document image classification, document layout analysis, table detection, and text detection for Optical Character Recognition (OCR).

Referring still to FIG. 2, the refined feature maps are then processed by the U-Net decoder 222, which generates the synthetic image 224. This image is a visual representation of the person wearing the garments in the desired layout, providing a high-resolution and detailed output of the multi-garment virtual try-on and editing process.

The system architecture depicted in FIG. 2 allows for a streamlined and efficient process. By separating the tasks of encoding the person, the garments, and the text input, the system can effectively disentangle the various features and aspects of the virtual try-on task. This separation allows for a more accurate and detailed output, as each component can focus on its specific task without being influenced by irrelevant information.

In some implementations, the system can also incorporate additional components or processes. For instance, the system could include additional encoders for processing additional garments or additional types of inputs. The system could also include additional layers or modules within the U-Net encoder 218, the DiT transformer 220, or the U-Net decoder 222 to further refine the output.

For example, the system could include a third garment encoder for processing a third garment image and corresponding pose data, allowing the person to virtually try on three garments at once. Alternatively, the system could include additional text encoders for processing additional text inputs, allowing the user to specify more complex or detailed layouts.

The system could also incorporate additional training or finetuning processes to improve the accuracy and realism of the output. For example, the system could employ a progressive training strategy, starting with lower-resolution images and gradually moving to higher-resolution images during training. This strategy could allow the model to better learn and refine high-frequency details, resulting in a more detailed and accurate synthetic image.

In terms of finetuning, the system could specifically finetune the person features, focusing on capturing and preserving the person's identity in the synthetic image. This strategy could significantly reduce the finetuned model size per new individual, making the system more efficient and practical.

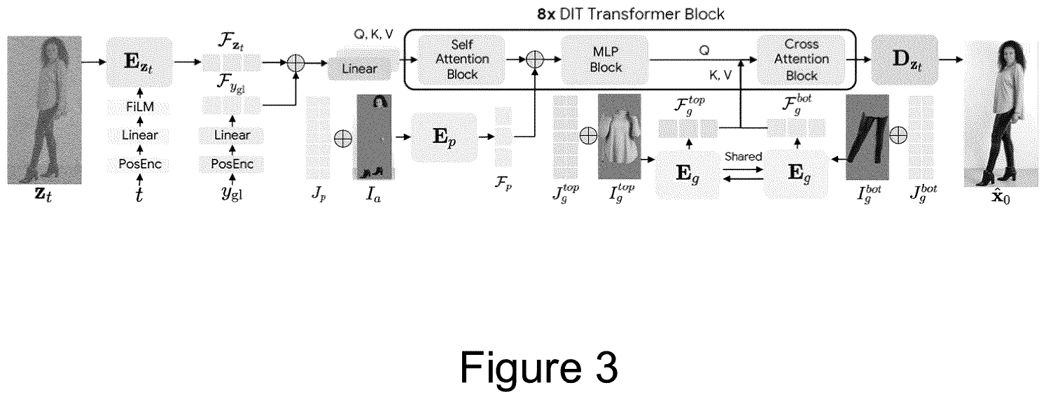

FIG. 3 provides an exemplary schematic representation of an embodiment of the VTO-UDiT architecture. The architecture includes several elements, such as UNet encoders, feature maps, embeddings, and a decoder, each playing a role in the process of synthesizing a realistic and high-resolution image of a person wearing multiple garments.

The UNet encoders, denoted as E_{z}_{ₜ}, Eₚ, and E_{g} in FIG. 3, are designed to process the image inputs, which may include a noisy image corrupted from the ground truth, a clothing-agnostic image of the person, and a segmented garment image. The UNet encoders extract feature maps from these images, with the feature maps being denoted as F_{z}_{ₜ}, Fₚ, and F_{g}^{κ} respectively. In the context of the present disclosure, ‘κ’ may refer to the upper-body garment, the lower-body garment, or the full-body garment.

Feature maps are helpful in image processing and convolutional neural networks. They capture and represent significant features from the input images, such as the shape, texture, and color of the garments and the person's body. The extracted feature maps can provide valuable information for the subsequent generation of the synthetic try-on image.

Following the extraction of feature maps, the diffusion timestep ‘t’ and garment attributes ‘y_{gl}’ are embedded using sinusoidal positional encoding. This is then followed by a linear layer, leading to the generation of the embeddings Fₜ and F_{y}_{_{gl}}. The embeddings play a role in modulating the features with FiLM or concatenating to the key-value feature of self-attention in DiT.

The FiLM or Feature-wise Linear Modulation is a technique that allows for the modulation of one feature map based on the other. This technique can be used to modulate the features extracted from the noisy image and the clothing-agnostic image of the person based on the garment attributes. This modulation can improve the accuracy and realism of the synthetic try-on image.

The architecture can also include a mechanism for spatially aligning features and implicitly warping F_{g}^{κ} with cross-attention blocks. Spatial alignment of features can include aligning the features extracted from the noisy image and the clothing-agnostic image of the person. Implicit warping of F_{g}^{κ} can refer to the process of transforming the garment features based on the person's body shape and pose. The cross-attention blocks, in this context, can allow the model to attend to different parts of the feature maps selectively, enhancing the accuracy of the warping process.

A final stage of the architecture can include the generation of the denoised image \hat{x}₀ with the decoder D_{z}_{ₜ}. The decoder can be architecturally symmetrical to the encoder E_{z}_{ₜ}, which can ensure consistency and balance in the architecture. The decoder takes the modulated and warped features and synthesizes the final high-resolution image. The generated image provides a realistic visualization of how the person would look wearing the garments in the desired layout.

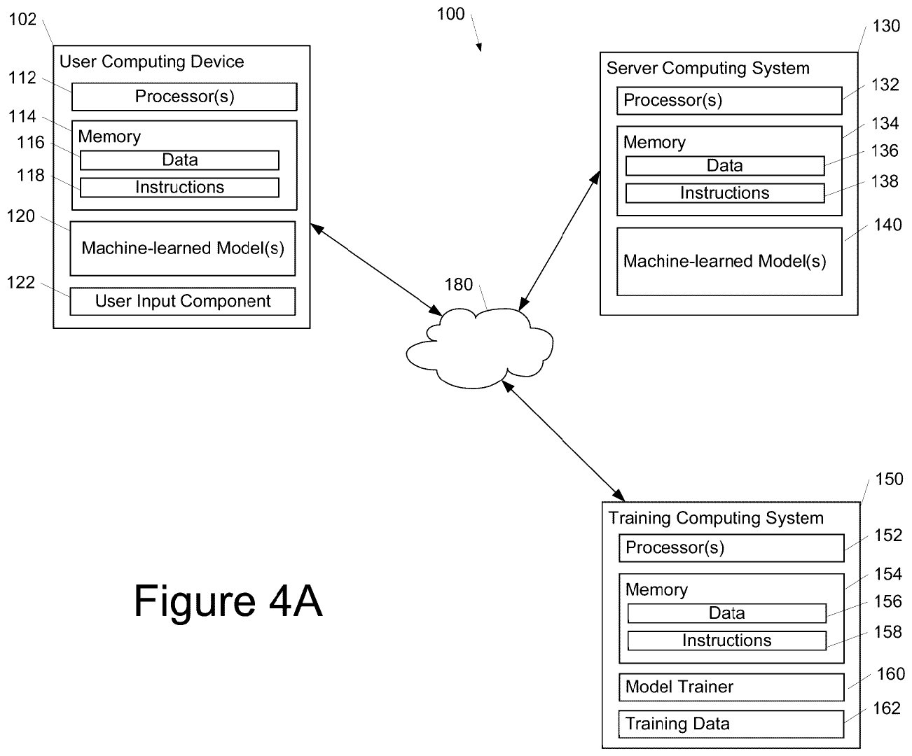

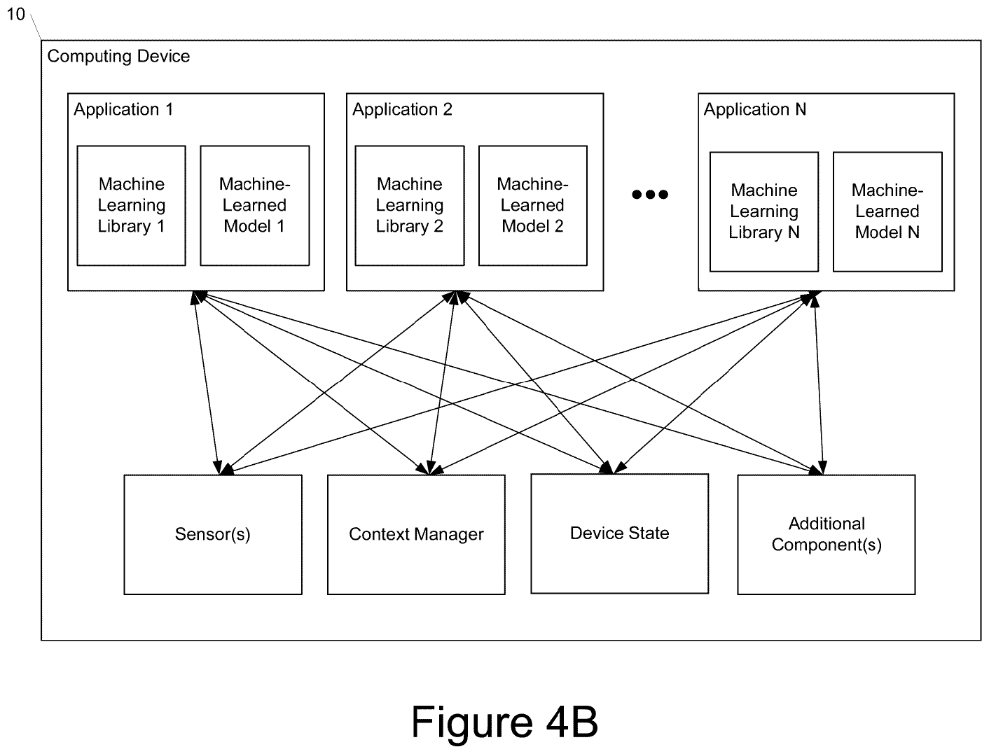

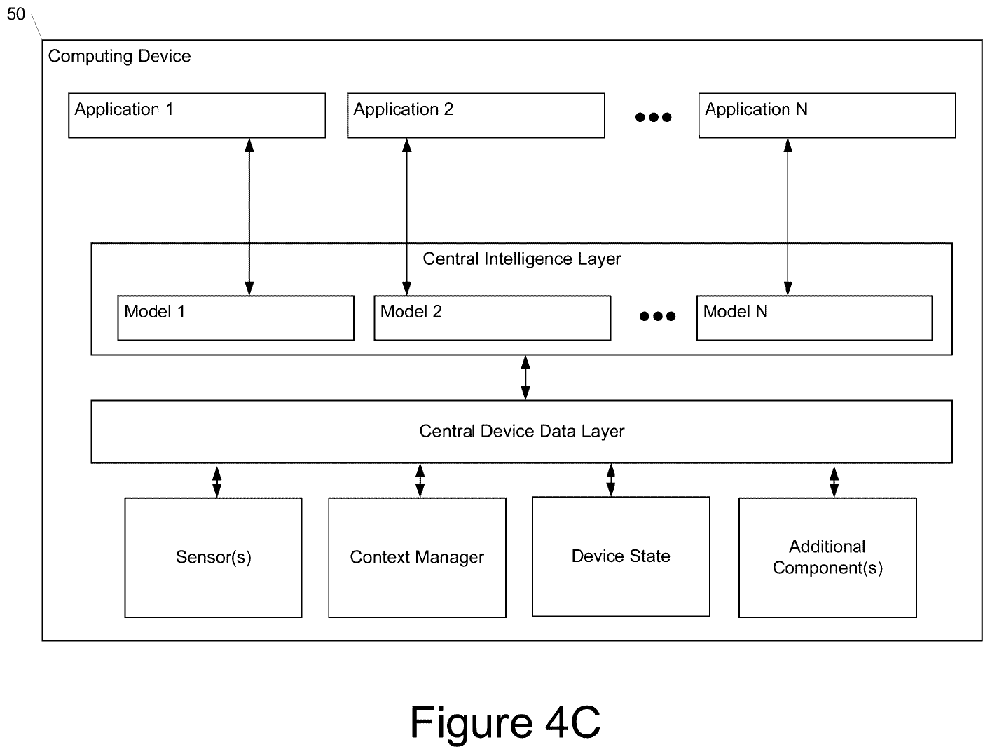

FIG. 4A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-3.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel image generation across multiple instances of input sets).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a virtual try-on service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-3.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 4A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 4B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 4B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 4C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 4C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 4C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method for multi-garment try-on, the method comprising:
obtaining, by a computing system comprising one or more computing devices, an input set comprising a person image that depicts a person, a first garment image that depicts a first garment, and a second garment image that depicts a second garment;
processing, by the computing system, the input set with a machine-learned denoising diffusion model to generate, as an output of the machine-learned denoising diffusion model, a synthetic image that depicts the person wearing the first garment and the second garment; and
providing, by the computing system, the synthetic image as an output.

2. The computer-implemented method of claim 1, wherein the denoising diffusion model comprises a single-stage denoising diffusion model.

3. The computer-implemented method of claim 1, wherein the input set further comprises a textual layout description.

4. The computer-implemented method of claim 3, further comprising:
processing, by the computing system, the textual layout description with a text embedding model to generate a text embedding, wherein the text embedding model has been finetuned on training data comprising clothing descriptions.

5. The computer-implemented method of claim 1, wherein the machine-learned denoising diffusion model comprises a first garment encoder configured to generate a first garment embedding from the first garment image and a second garment encoder configured to generate a second garment embedding form the second garment image.

6. The computer-implemented method of claim 1, wherein the machine-learned denoising diffusion model comprises a person encoder configured to generate a person encoding from the person image, a U-Net encoder, and a U-Net decoder.

7. The computer-implemented method of claim 6, wherein only the person encoding has been finetuned.

8. The computer-implemented method of claim 6, wherein the machine-learned denoising diffusion model operates over multiple denoising time steps, wherein the U-Net encoder takes a current time step as an input, and wherein one or more of the first garment encoder, second garment encoder, and person encoder operate only once to generate persistent embeddings.

9. The computer-implemented method of claim 1, wherein the input set further comprises first garment pose data, second garment pose data, and person pose data.

10. The computer-implemented method of claim 1, wherein the machine-learned denoising diffusion model has been progressively trained on increasing image resolutions.

11. A computer system configured to train a denoising diffusion model to perform virtual try-on by performing operations, the operations comprising:
performing a plurality of training iterations, each training iteration comprising:
obtaining an image pair, the image pair comprises a target image of a person wearing a garment and a garment image of the garment;
creating a garment-agnostic image of the person based on the target image and the garment image;
processing the garment image and the garment-agnostic image of the person with the denoising diffusion model to generate a synthetic image that depicts the person wearing the garment; and
modifying one or more values of one or more parameters of the denoising diffusion model based on a loss function that compares the synthetic image to the target image;
wherein the plurality of training iterations are performed over at least two training stages, wherein a first training stage is performed on images having a first resolution, and wherein a second, subsequent training stage is performed on images having a second resolution that is larger than the first resolution.

12. One or more non-transitory computer-readable media that collectively store computer-executable instructions, that when executed by a computing system, cause the computing system to perform operations, the operations comprising:
obtaining, by the computing system, an input set comprising a person image that depicts a person, a first garment image that depicts a first garment, and a second garment image that depicts a second garment;
processing, by the computing system, the input set with a machine-learned denoising diffusion model to generate, as an output of the machine-learned denoising diffusion model, a synthetic image that depicts the person wearing the first garment and the second garment; and
providing, by the computing system, the synthetic image as an output.

13. The one or more non-transitory computer-readable media of claim 12, wherein the denoising diffusion model comprises a single-stage denoising diffusion model.

14. The one or more non-transitory computer-readable media of claim 12, wherein the input set further comprises a textual layout description.

15. The one or more non-transitory computer-readable media of claim 14, further comprising:
processing, by the computing system, the textual layout description with a text embedding model to generate a text embedding, wherein the text embedding model has been finetuned on training data comprising clothing descriptions.

16. The one or more non-transitory computer-readable media of claim 12, wherein the machine-learned denoising diffusion model comprises a first garment encoder configured to generate a first garment embedding from the first garment image and a second garment encoder configured to generate a second garment embedding form the second garment image.

17. The one or more non-transitory computer-readable media of claim 12, wherein the machine-learned denoising diffusion model comprises a person encoder configured to generate a person encoding from the person image, a U-Net encoder, and a U-Net decoder.

18. The one or more non-transitory computer-readable media of claim 17 wherein only the person encoding has been finetuned.

19. The one or more non-transitory computer-readable media of claim 17, wherein the machine-learned denoising diffusion model operates over multiple denoising time steps, wherein the U-Net encoder takes a current time step as an input, and wherein one or more of the first garment encoder, second garment encoder, and person encoder operate only once to generate persistent embeddings.

20. The computer-implemented method of claim 1, wherein the input set further comprises first garment pose data, second garment pose data, and person pose data.
